(19) United States
(12) Patent Application Publication
(10) Pub. No.: US 2008/0210372 A1
(43) Pub. Date: Sep. 4, 2008

(54) COMPOSITE ARTICLE DEBULKING PROCESS

(76) Inventors: ROBERT C. CUMINGS, St. Peters, MO (US); Terence Gerard Vanderbos, Wright City, MO (US)

Correspondence Address: SHUGHART THOMSON & KILROY, PC, 120 WEST 12TH STREET, KANSAS CITY, MO, 64105, US

(21) Appl. No.: 12/041,401

(22) Filed: Mar. 3, 2008

Related U.S. Application Data
(60) Provisional application No. 60/904,271, filed on Mar. 1, 2007.

(51) Int. Cl. B29C 65/00

(52) U.S. Cl. 156/286

(57) ABSTRACT

A process for debulking a fiber reinforced composite structure prior to curing includes forming a stackup of a breather pad on a vacuum plate, a mandrel on the breather pad, a first release layer on the mandrel, a plurality of prepreg plies on the release first layer, a second release layer on the top ply, a breather sheet on the second release layer, and an impervious flexible vacuum bag sealed over the breather sheet to the vacuum plate; sealingly enclosing the stackup within a pressure vessel including an impervious flexible membrane which engages the vacuum bag; drawing a vacuum from within the vacuum bag through the breather pad and the vacuum plate; pressurizing the pressure vessel between the shell and the membrane; and maintaining the combination of vacuum and pressure for an interval of time to remove voids and porosity from the laminated prepregs.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 60/904,271 for APPARATUS AND METHOD FOR DEBULKING A COMPOSITE MATERIAL, filed Mar. 1, 2007, and which is incorporated herein by reference.

### BACKGROUND OF THE INVENTION

The present invention is generally directed to the manufacture of fiber reinforced composite structures and articles and, more particularly, to methods and apparatus for debulking such structures to remove porosity defects and discontinuities from such structures, which result from gases and gas voids within such structures at interim stages of the manufacture thereof.

Composite materials or composites are engineered materials made from two or more constituent materials with significantly different physical and/or chemical properties and which remain separate and distinct within the finished structure but which cooperate to form a material with particular physical properties. Composite materials such as laminated fiber-reinforced composites may consist of various fiber reinforcements such as fiberglass, aromatic polyamide (such as Kevlar®), boron, carbon, or similar materials in a resin matrix. The matrix may be formed of polyester, vinyl ester, epoxy, phenolic, polyimide, polyamide, polypropylene, polyetheretherketone (PEEK), also referred to as polyketone, or the like which are thermoset polymers. It is also known to form composites using thermoplastic polymer matrices.

One type of uncured laminated fiber-reinforced composite material are referred to as “prepregs”, that is, fiber material pre-impregnated with a resin, and which incorporate the fibers in the matrix in an uncured state. One method of manufacturing an item from these prepreg materials utilizes the layering of plies of the prepreg materials on a tool or mandrel which functions as a mold to shape the structure to be produced. The plies may be positioned in various orientations depending up on the type and fiber orientation of the prepreg material. Typically, one ply or a group of plies is positioned on the tool or mandrel, and hand or machine pressure is used to conform the prepreg plies to the tool or mandrel. Pressure is applied to remove or ensure that there are no wrinkles in the material and to remove any trapped air in between the plies. This lay-up process is repeated until the required thickness of prepreg material is achieved. The lay-up process may also be achieved mechanically utilizing tape laying machines which position typically narrow widths of prepreg plies onto the tooling.

Both hand and mechanical lay-up processes can leave air trapped between the layers of plies of the prepreg materials. If this are is not removed before the curing process of the material, the air may stay trapped and create discontinuities in the final cured material or part. These discontinuities create inherent flaws in the material which may weaken the structure or reduce the quality of the part. Such discontinuities may include porosity, micro-porosity, voids, micro-voids, linear porosity and may contribute to ply slippage during curing, ply wrinkles, and may be the origin of the formation of delaminations between layers of the composite after it is cured. Further, volatiles trapped in the matrix or resin of the composite materials may also become trapped during the curing process. These trapped volatiles may also contribute to discontinuities and porosity.

A known method to reduce the air trapped during the lay-up process of the composite structure is to use a process called debulking. Typical debulking processes utilize drawing a vacuum on the pre-cured lay-up to both conform the plies to the tooling and force any trapped air or gases from between the layers. Typically a release film and breather cloth is placed on top of the plies with a vacuum bag placed on top. A flexible sealant material is used to seal the bag to the tooling or mandrel and a vacuum pump is utilized to evacuate the air out encased materials. The debulked assembly may be disconnected from the vacuum source and placed in an autoclave and cured at temperatures sufficient to cause the resin matrix to gel and cure. Alternatively, the debulked assembly may be cured while still under vacuum to assist in the removal of any out-gassing volatiles in the matrix resin which may be released during curing.

FIG. 1 diagrammatically illustrates components of a representative type of conventional debulking process 300 for extracting voids from an uncured laminate composite assembly 302. The process 300 includes a mandrel 304 for shaping the assembly 302 and which is supported on a support base 306. The illustrated process includes a nonporous release sheet 308 overlaid on the mandrel 304. A plurality of laminate sheets or prepregs 310 are overlaid on the release sheet 308, either mechanically or manually. As each prepreg 310, or as small groups of the prepregs 310, is placed, it may be pressed by hand or using some kind of a roller or squeegee to remove visible air pockets. Once the required number of prepregs 310 have been laid to form the assembly 302, an additional nonporous release sheet 312 may be overlaid on the assembly 302. A porous breather material 314 is positioned over the release sheet 312 and sealed to the mandrel 304. Finally, an impervious membrane or “vacuum bag” 316 is placed over all the components and sealed to the mandrel 304, as by a sealant material 318. Once the vacuum bag 316 is in place, a vacuum is drawn from within the vacuum bag 316, for example, through passages (not shown) formed in the support base 306 and the mandrel 304 to draw entrapped air and out-gassed volatiles from the assembly 302. Additional information on conventional methods and apparatus for debulking uncured composite assemblies may be found in U.S. Pat. No. 5,106,568, which is incorporated herein by reference, and from other sources.

While conventional processes for debulking composite structures prior to curing may be adequate for structures used in non-critical applications and in terrestrial environments, conventional process tend to leave some voids within the structures. When composite structures formed by conventional processes are placed in more critical applications, such as in components for aerospace applications, the extreme environments and loads that the structures are subjected to reveal the weaknesses caused by such voids and porosities in accelerated breakdown of the components and occasionally in catastrophic failures.

### SUMMARY OF THE INVENTION

The present invention provides an improved process for debulking uncured fiber reinforced composite structures and improved apparatus for debulking such structures.

In general, the present invention provides a composite structure debulking process which combines negative pressure with a relatively high positive pressure at ambient temperatures to debulk an uncured composite structure.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a diagrammatic cross section of a prior art debulking apparatus and illustrates components used in forming a debulked composite article.

FIG. 2 is a diagrammatic cross section of an embodiment of a debulking apparatus according to the present invention along with components used in forming a debulked composite article.

FIG. 3 is a flow diagram illustrating the principal steps in an embodiment of a process for debulking composite articles according to the present invention.

FIG. 4 is a fragmentary perspective view of an embodiment of a debulking station according to the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

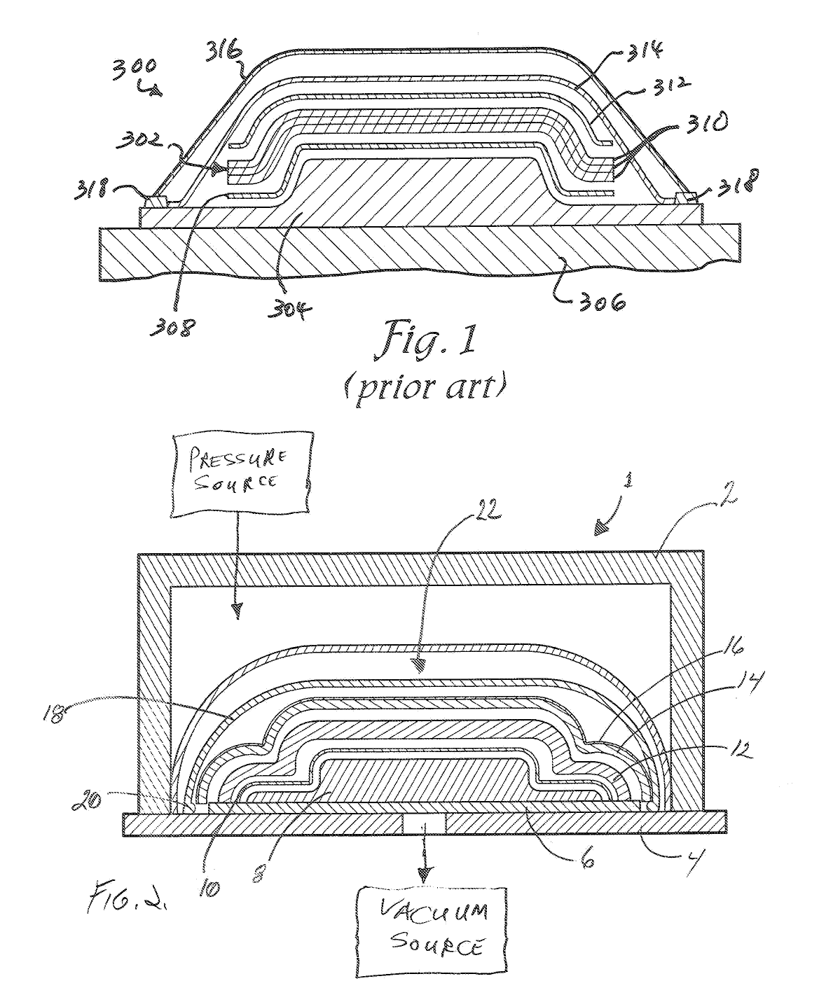

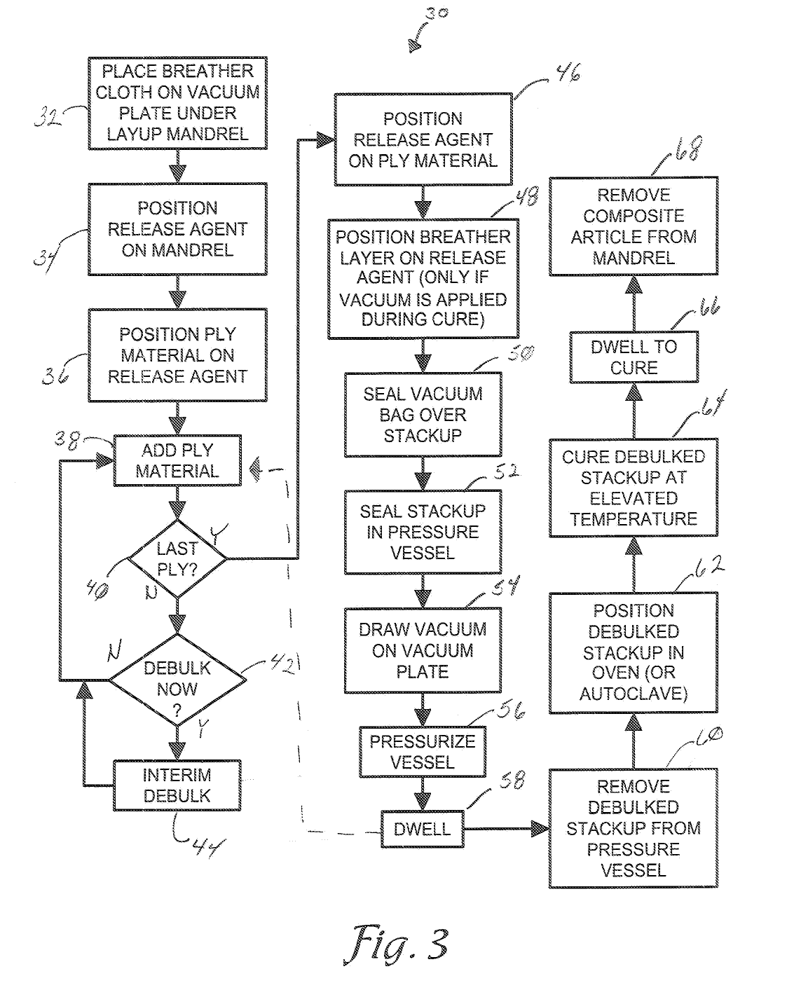

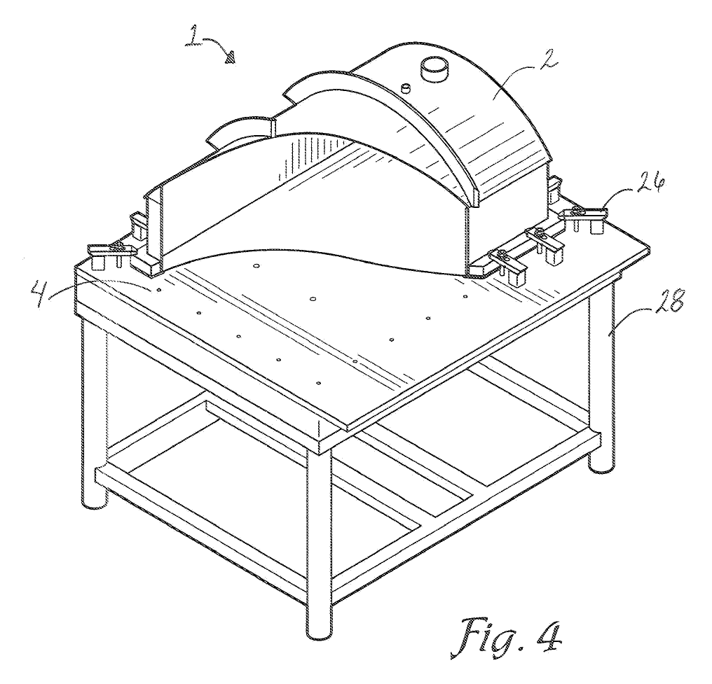

Referring now to the drawing figures, the reference numeral 1 refers to an improved debulking chamber in accordance with the invention, which is depicted in FIGS. 1 and 4 in association with an improved debulking process shown in FIG. 3.

As best shown in FIG. 2, improved debulking chamber 1 is comprised of a pressure vessel 2, capable of pressures ranging from 1 to 20 or more atmospheres. Improved debulking chamber 1, also utilizes a vacuum plate 4 which is operatively connected to a vacuum source (not shown). During a typical composite manufacturing process which utilizes the improved debulking process and vacuum during the curing process, a breather pad 6 is placed on top of vacuum plate 4. In applications were the manufacturing process will not use vacuum during the curing cycle, breath pad 6 may be omitted. A mandrel 8 which is used to form the composite part is placed on top of breather pad 6 (if utilized). Release agent 10 is placed on top of mandrel 8 to prevent the composite and resin materials from adhering to mandrel 8. Release agent 10 may consist of a film or spray type materials. Ply material 12 is place on mandrel 8 on top of release agent 10. Ply material 12 may consist of a prepreg material in which the matrix is included with the reinforcing material such as carbon fiber, unidirectional fiber material or woven cloth, impregnated with epoxy resin. Alternative, ply material 12 may consist of material without the matrix material. In this arrangement, ply material 12 may be comprised of carbon fiber material, glass matte or rovings, or other reinforcing material requiring the debulking process during the manufacturing process. Resin material (not shown) is added to ply material 12 during the application of ply material 12 on mandrel 8. Bag release agent 14 is placed on top of ply material 12 to prevent ply material 12 from adhering to materials which will be stacked on top of ply material 12. Alternative, an intensifier (not shown) may be placed on top of ply material 12 either with or without bag release agent 14. An intensifier assists in the debulking process and forming of the resulting composite article. Placed on top of bag release agent 14 is bag release pad 16. Bag release pad 16 is option and may not be required for all composite manufacturing processes and may depend upon matrix and reinforcement materials used. Lastly, vacuum bagging material 18 is placed on top of bag release pad 16, if present and if it is not utilized, on top of bag release agent 14. Vacuum bagging material 18 is sealed to vacuum plate 2 utilizing a sealant material 20. A vacuum can be applied to vacuum plate 2 and extract the atmospheric air and air trapped inside stackup 22. Stackup 22 consists of all materials placed on top of vacuum plate 4 and contained by vacuum bagging material 18.

Pressure vessel 2 has a flexible membrane 24 operatively connected to the walls of pressure vessel 2 such that downward pressure is applied to flexible membrane 24 containing stackup 22 in pressure vessel 2. A vacuum is drawn on stackup 22 utilizing vacuum plate 4 and vacuum bagging material 18 while downward pressure is applied in pressure vessel 2.

An improved debulking process 30 is shown in FIG. 3. Improved debulking process 30 is described during the complete stackup process as figuratively shown in FIG. 2. First, breather pad 6 is placed on vacuum plate 4 and under mandrel 8 as shown in step 32. Alternatively, step 32 may be omitted if stackup 22 will not be under a vacuum during the composite cycle. Next, release agent 10 is placed on mandrel 8 at step 34. Release agent 10 prevents the composite article from adhering to mandrel 8 during the cure cycle. Ply material 12 is placed on release agent 10 at step 36. Multiple layers of ply material 12 may be place on mandrel 8 in accordance to part design as shown in step 38. Resin may also be added at step 36 depending upon the material used, prepreg materials or reinforcing material without a resin matrix such as carbon fiber cloth or glass matt or rovings. At step 40, the technician must determine if all ply material 12 has been added in accordance with the manufacturing process. Some manufacturing processes require multiple debulking cycles to remove gases and volatiles entrapped in the layers of materials. This is also advantageous for thick components that require multiple layers of materials. Alternatively, components of complex geometry have an increased likelihood that gases or volatiles will become entrapped in the radii or tight corners. Therefore, the improved debulking process 30 may be applied multiple times during the layup process of complex and thick composite articles.

If the last ply of material has been placed on the intermediate layup, at step 42, an interim debulk may be required as shown in step 44. An interim debulk consists of steps 46 through 58. Upon completion of the interim debulk, additional ply material 12 may be added as specified in step 38 and continued until the final ply material 12 has been laid up.

Turning to step 46, once ply material 12 is placed on mandrel 8, bag release agent 14 is place on top of ply material 12. Alternative, an intensifier (not shown) may be using in place of or in conjunction with bag release agent 14. An intensifier is used to increase the compression of ply material 12, especially with thicker layups and complex geometry articles.

At step 48, bag breather pad 16 is placed on top of bag release agent 14. This is typically used in applications when the composite will be cured under vacuum. Vacuum bagging material 18 is placed over the composite layup and sealed to vacuum plate 2 using sealant material 20 at step 50. Stackup 22 is then sealed in pressure vessel 2 by sealing flexible membrane 24 over stackup 22. At step 54, a vacuum is drawn utilizing vacuum plate 4. Once a vacuum had been achieved, typically in the range at a negative 0.5 to negative 2.0 atmospheres, downward pressure is now applied in pressure vessel 2 which applies positive pressure on flexible membrane 24 at step 56. Pressures may vary in the range of 1 or 20 atmospheres depending upon the desired result and the mandrel utilized. Steel mandrels and solid or thick aluminum mandrels can withstand higher pressures. However, disposable or short-life mandrels may only be able to withstand lower pressures before being crushed by the force applied.

Once pressure vessel 2 containing stackup 22 is pressurized, the stackup 22 remains under pressure in a dwell cycle as shown in step 58. If this is an interim debulk (step 44), more ply material 8 will be added and the process repeated as shown in step 38. If the process is not an interim debulk (step 44), the debulked stackup 22 is removed from pressure vessel 2 at step 60. If the stackup 22 is to be cured under vacuum, the vacuum is maintained on vacuum plate 2. If not, vacuum is removed. Stackup 22 is placed in an oven or autoclave for curing at step 62 and cured at an elevated temperature (step 64) which may range from 150° to 600° F. or higher depending upon the matrix and fiber reinforcement materials. Stackup 22 then dwells in the oven to cure at step 66 and the resulting composite article is removed from the oven and mandrel 8.

Improved debulking chamber 1 is shown in FIG. 4 with an cut-away illustrating pressure vessel 2 which cooperates with vacuum plate 4. Pressure vessel 2 is fixed to vacuum plate 4 utilizing removable clamps 26. After debulking had been achieved, stackup 22 positioned on vacuum plate 4 on top of frame 28 may be placed in the curing oven or autoclave (not shown). Alternatively, stackup 22 and vacuum plate 4 may be removed and place in the curing oven or autoclave (not shown).

It is to be understood that while certain forms of the present invention have been illustrated and described herein, it is not to be limited to the specific forms or arrangement of parts described and shown.

What is claimed and desired to be secured by Letters Patent is:

1. In a process for forming a fiber reinforced composite structure from an uncured composite subassembly of fiber ply material and a resin, the improvement comprising the step of:
(a) debulking said composite assembly by applying a combination of a negative pressure on one part of said composite assembly and a positive pressure on another part thereof to thereby remove voids from within said composite assembly prior to curing same.

2. A process as set forth in claim 1 and including the step of:
(a) applying said combination of negative pressure and positive pressure to said composite assembly at substantially an ambient temperature.

3. A process as set forth in claim 1 and including the steps of:
(a) sealing a flexible impervious membrane over said composite assembly prior to applying said negative pressure and said positive pressure;
(b) applying said negative pressure directly to said composite assembly within said membrane; and
(c) applying said positive pressure indirectly to said composite assembly by applying said positive pressure to said membrane.

4. A process as set forth in claim 1 and including the step of:
(a) overlaying said fiber ply material and a resin on a mandrel to form said composite assembly prior to applying said combination of pressures.

5. A process as set forth in claim 1 wherein applying said negative pressure includes the steps of:
(a) providing a vacuum plate through which a vacuum can be drawn;
(b) positioning a gas pervious breather pad on said vacuum plate;
(c) positioning a mandrel on said breather pad to receive and shape said composite assembly;
(d) sealing said composite assembly between said vacuum plate and an impervious flexible vacuum bag; and
(e) drawing a vacuum from within said vacuum bag through said breather pad and said vacuum plate to thereby evacuate said composite assembly.

6. A process as set forth in claim 1 wherein applying said positive pressure includes the steps of:
(a) providing a pressure vessel including a support base and a shell;
(b) sealing an impervious flexible membrane across said shell;
(c) positioning said composite assembly on said support base;
(d) enclosing said composite assembly by sealingly engaging said shell with said support base and with said membrane engaging said composite assembly; and
(e) applying said positive pressure between said shell and said membrane to thereby indirectly apply said positive pressure to said composite assembly.

7. A process as set forth in claim 1 and including the steps of:
(a) releasing said combination of a negative pressure and a positive pressure; and
(b) thereafter, reapplying said combination of a negative pressure and a positive pressure to said composite assembly.

8. A process for debulking an uncured fiber reinforced composite article to remove voids therefrom and comprising the steps of:
(a) overlaying plies of uncured composite material on one another to form a composite assembly;
(b) sealing a vacuum bag over said composite assembly;
(c) sealing said composite assembly and vacuum bag within a pressure vessel;
(d) drawing a vacuum from within said vacuum bag;
(e) pressurizing said vessel thereby applying pressure external to said vacuum bag; and
(f) continuing to draw said vacuum and pressurize said vessel for a selected interval to thereby remove voids from said composite assembly prior to curing same.

9. A process as set forth in claim 8 and including the step of:
(a) drawing said vacuum and pressurizing said vessel at substantially an ambient temperature.

10. A process as set forth in claim 8 and including the step of:
(a) overlaying said plies of uncured composite material on a mandrel to provide said composite assembly with a desired shape.

11. A process as set forth in claim 10 and including the step of:
(a) applying a release layer to said mandrel prior to overlaying said plies thereon to facilitate separation of said composite assembly from said mandrel.

12. A process as set forth in claim 8 and including the steps of:
(a) providing a vacuum plate through which a vacuum can be drawn;
(b) positioning a porous breather pad on said vacuum plate;
(c) positioning a mandrel on said breather pad;
(d) overlaying said plies of uncured composite material on a mandrel to provide said composite assembly with a desired shape;
(e) sealing said vacuum bag to said vacuum plate with said breather pad, said mandrel, and said composite assembly positioned between said vacuum plate and said vacuum bag; and
(f) evacuating said vacuum bag by drawing said vacuum through said breather pad.

13. A process as set forth in claim 8 and including the steps of:
(a) providing said pressure vessel with a support base and a shell;
(b) sealing an impervious flexible membrane across said shell;
(c) positioning said composite assembly within said vacuum bag on said support base;
(d) enclosing said composite assembly by sealingly engaging said shell with said support base and with said membrane engaging said vacuum bag; and
(e) pressurizing said vessel by applying positive pressure between said shell and said membrane to thereby indirectly apply pressure to said composite assembly through said membrane and said vacuum bag.

14. A process as set forth in claim 8 and including the steps of:
(a) releasing said vacuum from said vacuum bag and releasing pressure from said pressure vessel; and
(b) reapplying said vacuum to said vacuum bag and repressurizing said pressure vessel.

15. A process for debulking an uncured fiber reinforced composite article to remove voids therefrom and comprising the steps of:
(a) positioning uncured composite material on a mandrel located on a vacuum plate to form an uncured composite assembly;
(b) applying a release layer over said composite assembly;
(c) sealing a flexible impervious vacuum bag over said composite material;
(d) drawing a vacuum from within said vacuum bag through said vacuum plate to evacuate a volume therein;
(e) releasing said vacuum within said membrane;
(f) enclosing said composite assembly and said vacuum bag within a pressure vessel;
(g) again drawing a vacuum from within said vacuum gab through said vacuum plate;
(h) pressurizing said vessel; and
(i) continuing to draw said vacuum and pressurize said vessel for a selected interval to thereby remove voids from said composite assembly prior to curing same.

16. A process as set forth in claim 15 and including the step of:
(a) drawing said vacuum and pressurizing said vessel at substantially an ambient temperature.

17. A process as set forth in claim 15 and including the step of:
(a) applying a release layer to said mandrel prior to positioning said composite material thereon to facilitate separation of said composite assembly from said mandrel.

18. A process as set forth in claim 15 and including the steps of:
(a) positioning a porous breather pad between said mandrel and said vacuum plate; and
(b) drawing said vacuum from said vacuum bag through said breather pad and said vacuum plate.

19. A process as set forth in claim 15 and including the steps of:
(a) providing said pressure vessel with a support base formed by said vacuum plate and a shell;
(b) sealing an impervious flexible membrane across said shell;
(c) positioning said composite assembly within said vacuum bag on said support base;
(d) enclosing said composite assembly by sealingly engaging said shell with said support base and with said membrane engaging said vacuum bag; and
(e) pressurizing said vessel by applying positive pressure between said shell and said membrane to thereby indirectly apply pressure to said composite assembly through said membrane and said vacuum bag.

20. A process as set forth in claim 15 and including the steps of:
(a) releasing said vacuum from said vacuum bag and releasing pressure from said pressure vessel; and
(b) reapplying said vacuum to said vacuum bag and repressurizing said pressure vessel.

21. A process as set forth in claim 15 and including the steps of:
(a) drawing said vacuum to a negative pressure ranging from 0.5 to a negative 2.0 atmospheres.

22. A process as set forth in claim 15 and including the steps of:
(a) pressurizing said vessel at a range 0.1 to 20 atmospheres.
